(19) United States
(12) Patent Application Publication
(10) Pub. No.: US 2005/0126033 A1
(43) Pub. Date: Jun. 16, 2005

(54) Device for drying shoes, gloves, garments or the like

(75) Inventor: David Macher, Voitsberg (AT)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: THERM-IC PRODUCTS GmbH, Gleisdorf (AT)

(21) Appl. No.: 11/003,194

(22) Filed: Dec. 3, 2004

(30) Foreign Application Priority Data
Dec. 5, 2003 (DE) 103 58 042.5

(51) Int. Cl. F25B 21/02; F26B 3/00; F26B 7/00

(52) U.S. Cl. 34/343; 34/390; 34/476

(57) ABSTRACT

A device for drying shoes, gloves, garments or the like is proposed which comprises a fan producing a stream of air which fan is accommodated in a housing. The housing is provided with at least one air discharge opening which is connected to an air nozzle. Arranged inside the housing or a tube connected with the housing is a closable cavity with a cover in which a carrier provided with essential oils is accommodated, wherein the cover is to be opened towards the air channel. The cavity is connected to the air channel only when the fan is in operation. In addition, at least one UV light emitting diode can be arranged in the stream of air whose radiation in association with the oxygen contained in the stream of air produces ozone for disinfection and deodorization.

The invention relates to a device for drying shoes, gloves, garments or the like according to the preamble of the main claim.

Such a device is disclosed in EP 1 253 848 B1. This device comprises a fan accommodated in a housing which fan produces a stream of air which is conveyed to two air discharge openings located opposite one another, wherein high connectors with tubes attached thereto are inserted in form-fitting manner into the air discharge openings. Arranged at the ends of the tubes are air discharge nozzles from which warmed air emerges. The tubes may, for example, be inserted into shoes which can be dried or heated up by the warm stream of air.

Japanese patent application 08 141 055 A discloses a dryer, for shoes for example, comprising a housing with a fan and a heating device as well as an air discharge nozzle. It furthermore comprises an ozone generator with alkaline ceramic which produces ozone for disinfection and deodorization.

The invention is based on the object of providing a device for drying shoes, gloves, garments or the like which simultaneously affords deodorization and a simple device for deodorization.

This task is solved according to the invention by the characterising characteristics of the main claim.

For deodorization and neutralisation of odours, in particular in a just freshly manufactured device which usually has a housing made of plastic an absorbent carrier impregnated with essential oils is provided which is arranged in the housing or the tube and gives off fragrance being carried by the stream of air to neutralise the odour of the plastic. Since the carrier e.g. constructed as a plate is accommodated in a cavity which is opened when the fan is in operation the service life of the aromatic plate is prolonged.

Advantageous refinements and improvements are possible by means of the measures specified in the subsidiary claims.

Due to the provision of a device for producing ozone having one or more light emitting diodes which emit radiation in the UV wavelength range by means of whose radiation ozone is producible a possibility for producing ozone is provided which serves both for neutralisation of odours and for disinfection, requires little space and hence does not make the device larger.

It is particularly advantageous when the cavity has a cover or a closing element which is opened by a removing or sliding movement or in opposition to an elastic force by the partial vacuum of the stream of air since this manner of opening requires no additional means.

Advantageously, the at least single UV light emitting diode is arranged on a printed circuit board or sheet which is fixed in place inside the housing and which can carry other electric and/or electronic components such as one or more light emitting diodes for display of functions, time control elements or voltage reduction elements or the like.

An exemplified embodiment of the invention is illustrated in the drawing and is explained in more detail in the following description.

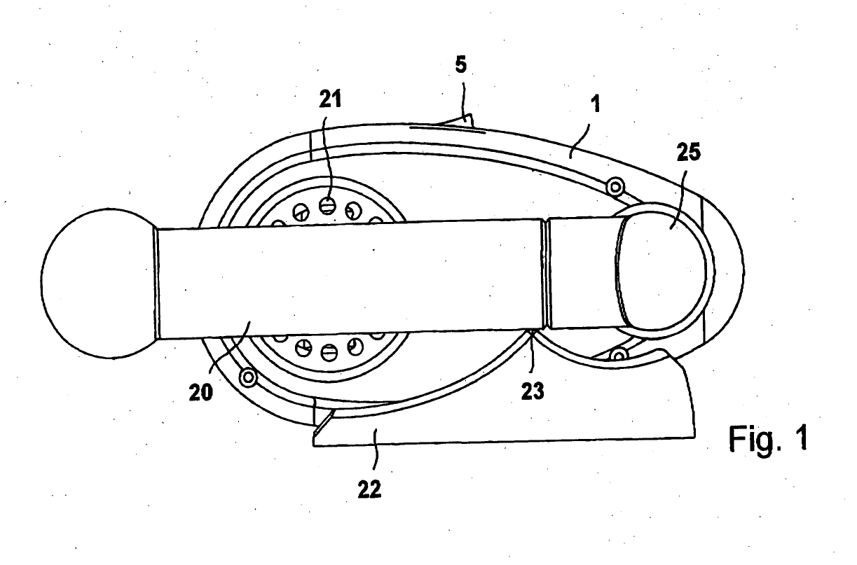

FIG. 1 shows a side view of the device according to the invention;

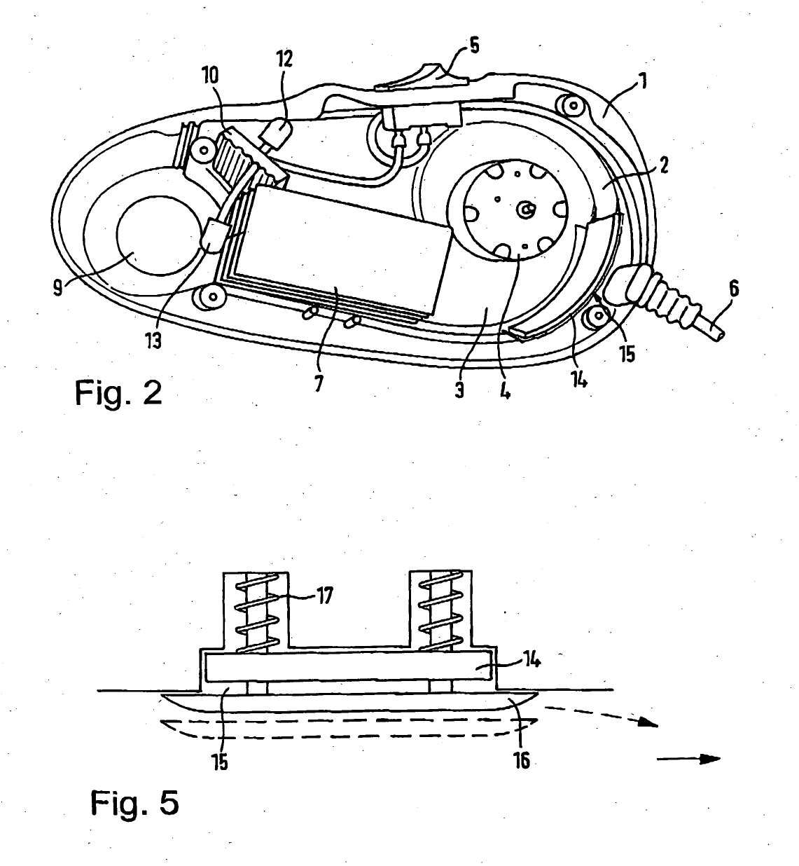

FIG. 2 shows a plan view onto an open housing of the device according to the invention;

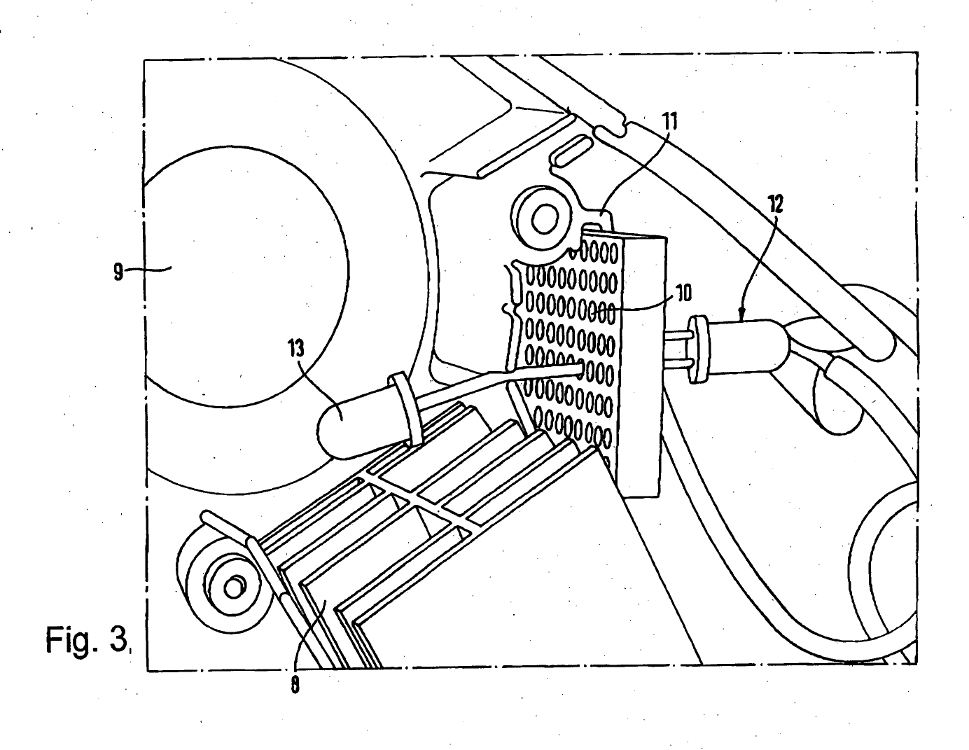

FIG. 3 is an enlarged illustration of the interior of the housing according to FIG. 2 with a light emitting diode according to the invention;

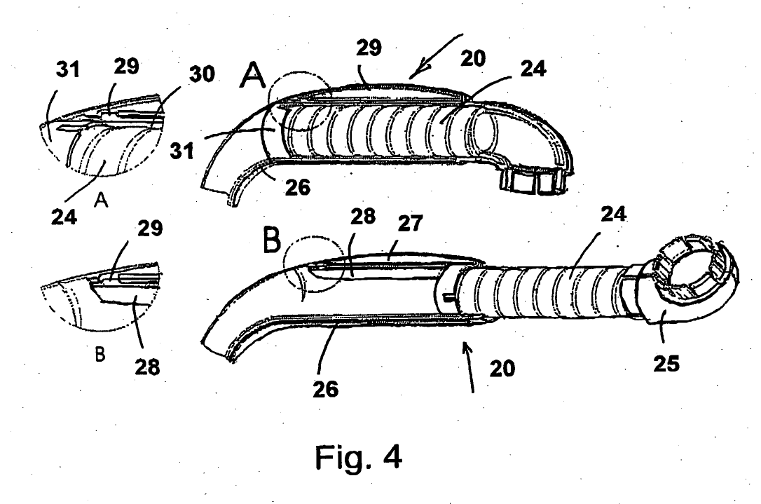

FIG. 4 is a sectional view through the telescopic tube with cavity in the assembled and the deployed state with enlarged extractions; and

FIG. 5 a schematic view of a cavity in the wall of the air channel with a cover.

The device shown in FIG. 1 for drying shoes, gloves or articles of clothing comprises a housing and two tubes or pipes 20 (only one is shown), which are attached to the housing and which are arranged directly adjacent to the housing 1 like arms. Such a device is disclosed in EP 1 253 848 B1, the disclosure of which should be included in this description. In the housing 1 are contained an electrically operated fan 4 as well as electrical components for driving the fan 4, wherein the electrical supply can be delivered via a cable from mains and/or a battery and/or a chargeable accumulator. To switch the fan on and off, a switch 5 is embedded in a narrow side wall of the housing 1. In the region of the fan 4 the housing 1 is provided with intake openings through which air is drawn from the outside by the fan 4. A stand element 22 with stops 23 for the tubes 20 can be an integral part of the housing or releasably connected to the housing.

In FIG. 2 an open housing part is illustrated, wherein the housing 1 consists of plastic and in the interior of the housing webs or walls 2 are moulded into place and constructed to define an air channel 3. Arranged inside the channel walls 2 is the fan 4 for producing a stream of air which fan is connected via the switch 5 to an electric power supply lead 6.

Downstream in the air channel 3 is a cooling block 7 (see also FIG. 3) provided with ribs 8 in or on which block heating elements which are not illustrated are mounted which heat up the stream of air flowing through from the fan 4. Further downstream in the housing 1 an air discharge opening 9 is provided, wherein another air discharge opening is moulded out in the housing part covering the illustrated housing part. In this air discharge opening 9 a tube connector is inserted in form-fitting and rotatable manner in which in turn the telescopic tube is accommodated (see FIG. 4), the open end of which forms an air nozzle or is provided with special nozzles.

In the wall 2 of the air channel 3 a cavity 15 is worked in as illustrated in more detail in FIG. 5. Located in this cavity 15 is an absorbent carrier, e.g. a strip of cardboard 14, impregnated with essential oils. In this case it is preferable for the fragrance of the essential oils to issue from a small area of the cardboard strip so that it retains this function for longer. This aromatic strip 14 serves in particular to neutralise the odour of the plastic from which the housing 1 is manufactured. This odour is present in particular in freshly injection-moulded plastic parts and is lost when the plastic parts having been in use for a relatively long time. Accordingly, the cardboard strip 14 provided with essential oils whose fragrance is likewise lost after very long use is particularly useful in a new device. The essential oils are chosen so that their fragrance neutralises the plastic odour particularly well.

In order, however, to prolong the service life of the aromatic strip the cavity 15 is provided with a cover 16 which is opened when the fan is in operation, but otherwise closed. For this purpose the cover is pretensioned in the closed state by two restoring springs 17. In the presence of a stream of air the cover is lifted off by the partial vacuum produced and the fragrance is given off to the stream of air.

However, different closing and opening devices for the cover or for a closing element closing the cavity are possible, wherein a further possibility is shown in FIG. 4.

FIG. 4 shows a telescopic tube 20 in the assembled (above) and the deployed (below) state, wherein enlarged extractions are referenced with A and B.

The telescopic tube 20 consists of two tube parts, a fixed tube part 24, which is lodged via the tube connector or socket in a form-locking way in the air discharge opening 9, and a displaceable tube part 26 which is slidable on the fixed tube part 24. In the wall region of the displaceable tube part 26 a chamber 27 is worked in a wall 28 with a connecting opening 29, separating the chamber from the inside of the tube guiding the air stream.

As can be seen from FIG. 4 above, an annular clearance 30 is formed between the wall of the displaceable tube part 26, including wall 28 and the fixed tube part 24 in the assembled state, the annular clearance 30 being sealed by sleeve or collar 31, fitted on the fixed tube part to the outside, namely to the open end of the tube part 26.

The aromatic carrier arranged within the chamber is emitting the fragrance through the connecting opening 29 and is enclosed in the annular clearance 30 when the telescopic tube 20 is assembled. When the tube 20 is extended for operation the fragrance is entrained by the air stream generated by the fan 4 and additionally is sucked through the connecting opening being then opened to the outside. The cavity enclosing the fragrance and which is closed when the device is out of operation is formed by the chamber 27 and the annular clearance 30.

As illustrated in FIG. 3 a printed circuit board 10 is inserted in guideways 11 in the interior of the housing in which at least one light emitting diode 12 for functional display and one UV light emitting diode 13 are fixed. The light emitting diode 12 for functional display is located behind a window in the housing 1 through which the light from the light emitting diode passes when the device is switched on.

The UV light emitting diode 13 is located downstream from the cooling block in front of the air discharge opening 9. Of course a plurality of UV light emitting diodes 13 may be arranged in the stream of air and be inserted on the printed circuit board 11. Likewise the printed circuit board can contain other electronic and/or electric components for controlling the mode of operation of the device.

When the fan 4 of the device is switched on the light emitting diode 12 for the functional display, the heating elements present in the cooling member 7 and the at least single UV light emitting diode 13 are also switched on. The UV radiation emitted by the UV light emitting diode 13 together with the oxygen present in the stream of air produces ozone which is transported along with the stream of air to the article to be dried or warmed up and serves to disinfect and neutralise odours.

1. Device for drying shoes, gloves, garments or the like comprising a fan producing a stream of air which fan is accommodated in a housing, the housing comprising at least one air discharge opening which is connected to an air nozzle via a tube; and a device for deodorization, the deodorization device constructed as an absorbent carrier impregnated with essential oils which gives off a fragrance, in particular for neutralizing the odour of the housing consisting of plastic, and which is accommodated in a sealable cavity which is opened when the fan is in operation.

2. Device according to claim 1, wherein the cavity is provided in the housing or the tube is sealable by a movable cover or closing element.

3. Device according to claim 2, wherein the cover is a movable sliding element which is operable when the fan is to be set into operation.

4. Device according to claim 2, wherein the tube is a telescopic tube consisting of several tube parts wherein the opening of the cavity is closed by tube part being in the assembled state and is opened when deployed.

5. Device according to claim 2, wherein the cover is opened by the partial vacuum produced when the fan is in operation acting in opposition to an elastic force which forces the cover into the closed position when the fan is switched off.

6. Device according to claim 1, wherein a device is provided for producing ozone for disinfecting the domain of action of the air stream.

7. Device according to claim 6, wherein the device for producing ozone comprises at least one UV light emitting diode by means of whose US radiation in association with the oxygen in the stream of air the ozone is producible.

8. Device according to claim 7, wherein inside the housing walls are provided to form an air channel from the fan to the air discharge opening, wherein a cooling block is arranged in the air channel to accommodate heating elements for heating up the stream of air conveyed through the cooling block, and the at least single UV light emitting diode is arranged between the cooling block and the air discharge opening.

9. Device according to claim 7, wherein the at least single UV light emitting diode is arranged on a printed circuit board which is connectable via a switch to an electric power supply.

10. Device according to claim 1, wherein a rotatable tube connector with a tube connected thereto is inserted in form-fitting manner into the air discharge opening.

11. Device according to claim 10, wherein two air discharge openings located opposite one another are provided with corresponding tube connectors and tubes.

12. Device according to claim 9, wherein the printed circuit board carries other electric and/or electronic components.
